(19) United States
(12) Patent Application Publication
(10) Pub. No.: US 2006/0150027 A1
(43) Pub. Date: Jul. 6, 2006

(54) System for monitoring and display of process control data

(75) Inventor: Thomas Cummings Paden, Hudson, MA (US)

Correspondence Address: WEINGARTEN, SCHURGIN, GAGNEBIN & LEBOVICI LLP, TEN POST OFFICE SQUARE, BOSTON, MA, 02109, US

(73) Assignee: Precision Digital Corporation

(21) Appl. No.: 11/005,133

(22) Filed: Dec. 6, 2004

(51) Int. Cl. G06F 11/00

(52) U.S. Cl. 714/39

(57) ABSTRACT

A data monitoring system is provided which is coupled to a data bus and which responds to identified data to cause the display of data from one or more designated sensors. The system can also provide outputs to activate and deactive relays and to control other devices. The programming and operation of a master controller does not have to be altered for use of the present system. The system operates to monitor one or more designated sensors and data from such sensors and to utilize the received data for display and/or operational purposes. The invention is especially useful in a process control network in which a large number of sensors is distributed throughout a facility and in which it is desirable to be able to read sensor data from one or more remote locations within a facility. The invention is also useful for other circumstances wherein data on a bus is to be monitored at a remote position.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

Sensors used in a process control facility are usually connected by a data bus to a central control room where data is monitored and displayed. It is often advantageous to have a local display at or near sensor locations so that field personnel can read such displays without the need of returning to or communicating with the control room. However, sensors may be mounted in inaccessible or inconveniently accessible locations and thus a display at such a location is often not convenient or practical for use. As an example, for monitoring fuel or other liquid levels in a tank farm, sensors are usually mounted on top of the tanks and a reading of a sensor display on the top of a tank would require a user to climb to the top to read the display.

A known technique for providing a local display of sensor data requires the use of an analog output module which is connected to a data bus. A digital panel meter is connected to the analog output module to provide the local display of data derived from the designated sensor or sensors. The central controller reads the sensor data and provides the resultant data to the analog output module which provides output data to the panel meter for display of desired parameters. This approach requires the addition of a bus-compatible analog output module and adds an additional processing burden on the central controller.

It would be desirable to have a system in which sensor data can be locally displayed without the necessity of an analog output module or other ancillary device and without requiring additional processing by the central controller.

### BRIEF SUMMARY OF THE INVENTION

In accordance with the present invention, a data monitoring system is provided which is coupled to a data bus and which responds to identified data to cause the display of data from one or more designated sensors or other data sources. The system can also provide outputs to activate and deactive relays and to drive other devices such as chart recorders, valve positioners, speed controllers and the like. The programming and operation of the master controller does not have to be altered for use of the present system. The system operates in effect as a sub-controller to monitor one or more designated sensors and data from such sensors and to utilize the received data for display and/or operational purposes.

The invention is especially useful in a process control network in which a large number of sensors is distributed throughout a facility and in which it is desirable to be able to read sensor data from one or more remote locations within the facility. The invention is also useful for other circumstances wherein data on a bus is to be monitored at a remote position.

### BRIEF DESCRIPTION OF THE SEVERAL VIEWS OF THE DRAWINGS

The invention will be more fully understood from the following Detailed Description, taken in conjunction with the accompanying drawings in which:

FIG. 1 is a block diagram of a monitor system in accordance with the invention;

FIG. 2 is a flowchart of monitor system operation; and

FIG. 3 is a pictorial representation of a digital panel meter in which the invention can be embodied.

### DETAILED DESCRIPTION OF THE INVENTION

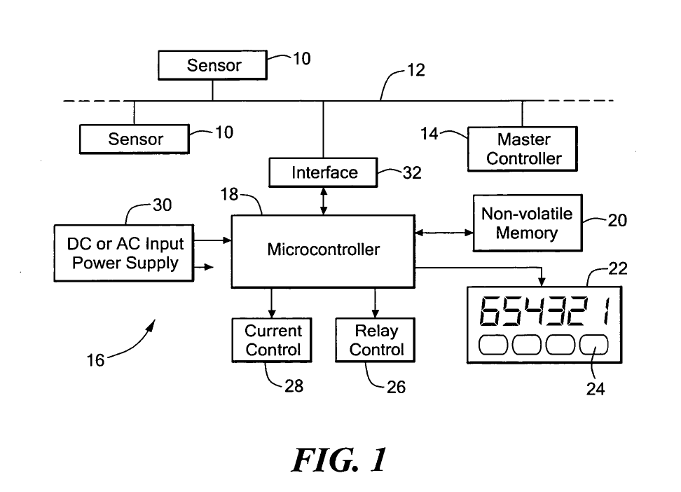

An embodiment of the invention is illustrated in FIG. 1. One or more sensors 10 are disposed in a process control or other facility for monitoring intended parameters such as temperature, pressure, liquid level, flow rate, etc. The sensors are coupled to a data bus 12 which is also coupled to a master controller 14. The controller, which is typically located at a control room of a process facility, is operative to send Read commands along the bus to the respective sensors and to receive data from the respective sensors for monitoring of control parameters and for storage, display and utilization of sensor data. The bus is preferably an RS485 ModBus which is a well known serial bus structure for interconnection of sensors and other devices in a process control, factory or other environment.

The system 16 includes a microcontroller 18 having a memory which contains a program governing microcontroller operation. The microcontroller is preferably a single chip microcontroller such as a Philips P89C61X2. A non-volatile memory 20 is connected to the microcontroller and contains configuration settings and address data. The microcontroller is connected to a digital input and display device 22 which is operative to display sensor data and is also operative to provide programming data to the microcontroller 18 via four pushbutton controls 24. The microcontroller also provides an output to a relay control 26 for control of one or more relays, and an output to a current control 28 which provides an output current to drive external devices. Power to the constituents of the system are provided by a DC or AC power supply 30. The microcontroller 18 is coupled to the bus 12 via a data interface 32. Where a ModBus is employed as the data bus, the data interface is typically an RS485 interface.

The system 16 can be located at any convenient location and coupled to the data bus via an interconnecting cable. A user at the system site can program addresses, using pushbuttons 24, of the one or more sensors from which data is to be read. Typically, the programmed data is a sensor address which specifies which sensor device is to provide the intended data, and a register address which specifies which data within the sensor device is to provide the intended data. The address data is stored in memory 20.

The master controller 14 provides Read commands to the sensors 10 which are communicated to the sensors on the bus 12. The Read commands include the addresses of the respective sensors from which data is desired. In response to a Read command, the corresponding sensor provides data which is communicated on the bus to the master controller 14. In response to a Read command containing one or more addresses which have been programmed into the microcontroller 18, the system 16 is enabled to await data from the designated sensor or sensors. A data packet from the designated sensor being communicated on bus 12 is received by the microcontroller 18 and the data is extracted from the packet and provided to device 22. The device 22 acts as a digital panel meter to provide a display of sensor data, and if programmed to do so, to provide output signals for control of relays, actuators or other output devices. Device 22 can also provide scaling, filtering and other signal processing functions typical of digital panel meters used for process control and related purposes.

The system operates independently of the master controller and does not require any alteration in usual master controller operation. The system can be implemented with power efficient circuits to utilize very little power and to not unduly load the bus. As an example, in accordance with the RS485 specification, 32 unit loads can be handled on a ModBus. System 16 can be constructed to have less than a unit load, such as a quarter or eighth load, by utilizing low power consumption circuitry to minimize additional loading of the bus.

The monitor system is programmable by a user at a remote or field site without any need for access to or communication with the master controller. The system is programmed to accommodate the particular data formats and specifications employed in a given network. The programming operation can be accomplished using the pushbutton controls 24 in any well known manner. For example, one or more of the control buttons can be actuated to enter a programming mode, with the buttons then being employed for entry of address characters. The system can be implemented to permit the programming of one or more sensors and the programming of one or more register addresses within each sensor unit. The address of each slave device to be monitored is entered and the address of each register within each slave device from which data is to be monitored is also entered. A slave response time can be entered to define a time interval within which a slave device must respond to a Read command. Calibration options can also be programmed into the monitor system as can scaling functions, and output options to define relay operation and/or to define current output operation.

The following programmable features are typically employed to program the monitor system. The address of the sensor to be monitored is entered. A register number is entered to specify which register to read in the designated sensor. The data type is entered to select the data format that the specified sensor employs. A response timeout period is entered to define a time interval within which the sensor must respond to a Read command to provide the data to be read by the monitoring system.

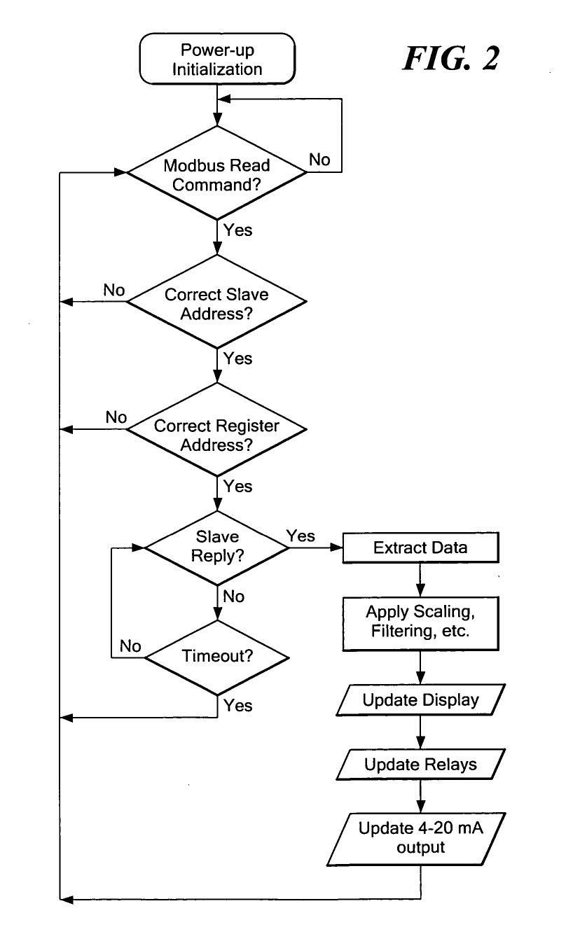

A flowchart of monitoring system operation is shown in FIG. 2. After power-up and initialization, the system awaits a Read command on the ModBus. Upon detection of a Read command the system determines whether or not a programmed slave address is present. If a programmed slave address is detected the system next determines the presence of a programmed register address. If the programmed register address is detected the system determines whether the slave unit has data to report. If there is such data the system extracts the data, applies appropriate scaling and filtering of the data and updates the display and relay and current outputs.

The monitoring system can be incorporated into a digital panel meter or can be implemented as a standalone device. When embodied in a digital panel meter, the system can share the hardware components, including the microcontroller, and have the usual functionality of a panel meter in addition to providing the novel monitoring functionality as described herein.

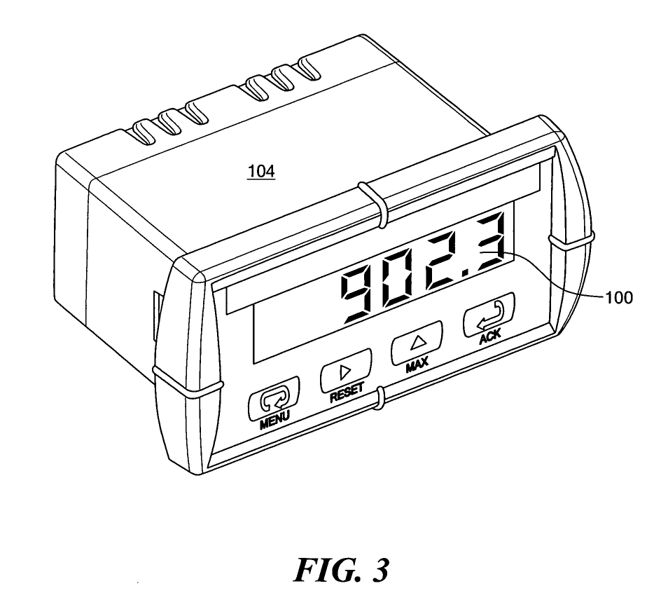

The monitoring system as contained in a digital panel meter is illustrated in FIG. 3 and includes a six digit LED display 100 and four pushbuttons 102 contained in a housing 104. The buttons are respectively labeled MENU, RESET or right arrow, MAX or up arrow and ACK (acknowledge or enter). The MENU button is pressed to enter or exit a programming mode. The right arrow button is pressed to move to the next digit during digit programming. The up arrow button is pressed to scroll through menu options, set a decimal point and to increment the value of a digit. The ACK button is pressed to access a menu or accept a setting.

The panel meter in which the monitor device can be embodied, can also operate in a slave mode wherein the meter receives data from a master controller for display and use.

It will be appreciated that the invention can be implemented in various other ways utilizing circuitry known in the art. For example, various single chip or other controllers can be employed having internal and/or external memory storage. Accordingly, the invention is not to be limited by what has been particularly shown and described and is to encompass the full spirit and scope of the appended claims.

What is claimed is:

1. A system for monitoring data from one or more sources being transmitted on a bus, comprising:
a data interface connectable to the bus and for receiving data from the bus;
a memory for storing one or more addresses of one or more sources;
a microcontroller operative upon recognition of a predetermined address associated with data on the bus to store the data associated with the predetermined address; and
an output device operative to display an output indication of the stored data.

2. The system of claim 1 wherein the microcontroller is operative to detect a Read command on the bus containing the predetermined address and thereafter to receive the data associated with the predetermined address.

3. The system of claim 1 wherein the output device includes a digital panel meter having a multi digit display and a plurality of control buttons.

4. The system of claim 3 wherein the control buttons are used to enter an address of each source to be monitored.

5. The system of claim 1 wherein the output device provides one or more output signals for control of utilization devices.

6. For use in a process control network having a master controller, one or more sensors each providing data representing a process parameter, and a data bus to which the one or more sensors and the master controller are connected, a data monitor comprising:
a data interface connectable to the data bus and operative to monitor data packets being communicated on the bus;
a microcontroller coupled to the data interface and having a memory and operative to store one or more addresses of predetermined sensors programmed by a user at the monitor;
a control circuit coupled to the microcontroller for programming said one or more addresses into the microcontroller;
the microcontroller being operative upon recognition of a predetermined address associated with a data packet on the bus to store the data associated with the predetermined address; and
an output circuit to display an output indication representative of the stored data.
